(19) United States
(12) Patent Application Publication
(10) Pub. No.: US 2003/0197681 A1
(43) Pub. Date: Oct. 23, 2003

(54) Wireless mouse signal transferring device

(76) Inventor: Hui-Pin Liang, Taipei (TW)

Correspondence Address: Hui-Pin Liang, 235 Chung-Ho, Box 8-24, Taipei, TW

(21) Appl. No.: 10/127,150

(22) Filed: Apr. 22, 2002

(51) Int. Cl. G09G 5/08

(52) U.S. Cl. 345/163

(57) ABSTRACT

A wireless mouse signal transferring device having a wireless mouse, a wireless receiver, a computer mainframe, an antenna, a keyboard connected to a computer mainframe. The wireless receiver is hidden in a predetermined position of a keyboard and is connected with an antenna, the antenna is hidden in an edge of the keyboard; thereby, the antenna is near the wireless mouse, thereby, the space for locating the wireless mouse is saved and thus less power is required in signal transmission.

### FIELD OF THE INVENTION

The present invention relates to a wireless device, and particularly to wireless mouse signal transferring device, wherein a wireless receiver is hidden in a predetermined position of a keyboard, and is connected with an antenna; the antenna is hidden in an edge of the keyboard; thereby, the antenna is near the wireless mouse, and the space for locating the wireless mouse is saved. Thus less power is required in signal transmission.

### BACKGROUND OF THE INVENTION

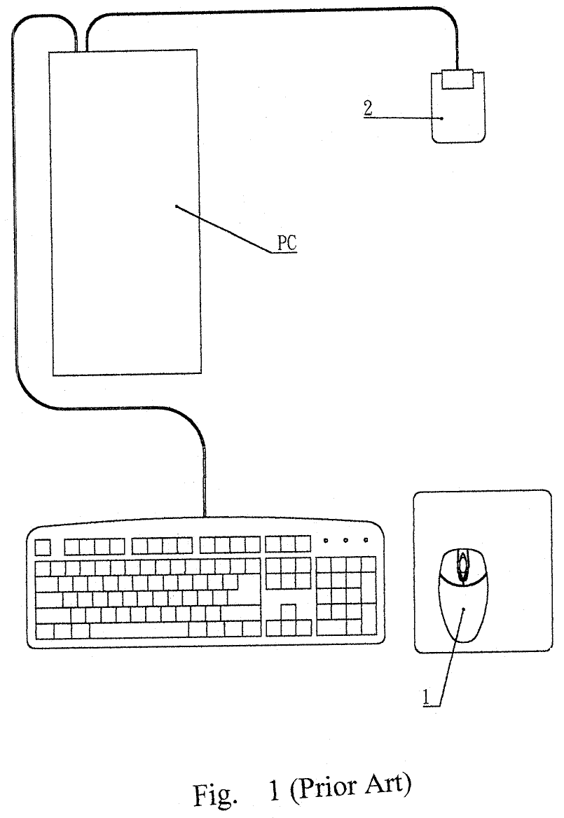

In general, the signal wire and power wire of a wired mouse is connected to an IC circuit board of a computer mainframe. Since the power wire and signal wire are directly connected to a mouse. Thereby, when the user holds and operates a mouse, he (or she) will be hindered by the power or signal wires so that the mouse can not be operated precisely, even the cursor on the display can not be well controlled. As a result, wireless mice are developed, referring to FIG. 1, so as to prevent from using power wire and signal wire. However, the wireless mouse must be used with a wireless receiver 2 and then a box is used to enclose the mouse and the wireless receiver. Then a signal wire extending from the box is connected to the motherboard in the computer mainframe, Thereby, the wireless receiver 2 will receive signals emitted from the transmitter of the wireless mouse 1, but in this prior art design, a space is required for locating the box. Moreover, for the wireless receiver to receive the signals from the wireless mouse, the output power of the transmitter of the wireless mouse must be amplified when the wireless mouse 1 and the wireless receiver 2 are placed far away. Although the signals can be received, the cost is increased.

### SUMMARY OF THE INVENTION

Accordingly, the primary object of the present invention is to provide a wireless mouse signal transferring device which can improve the defects in the prior art.

To achieve above objects, the present invention provides a wireless mouse signal transferring device having a wireless mouse, a wireless receiver, a computer mainframe and a keyboard; characterized in that: the wireless receiver is hidden in a predetermined position of a keyboard and is connected with an antenna; the antenna is hidden in an edge of the keyboard. Thereby, the antenna is near the wireless mouse, and the space for locating the wireless mouse is saved. Less power is required in signal transmission.

The various objects and advantage of the present invention will be more readily understood from the following detailed description when read in conjunction with the append drawing.

### BRIEF DESCRIPTION OF THE INVENTION

FIG. 1 is a schematic view showing the arrangement of a prior art wireless mouse and a wireless receiver.

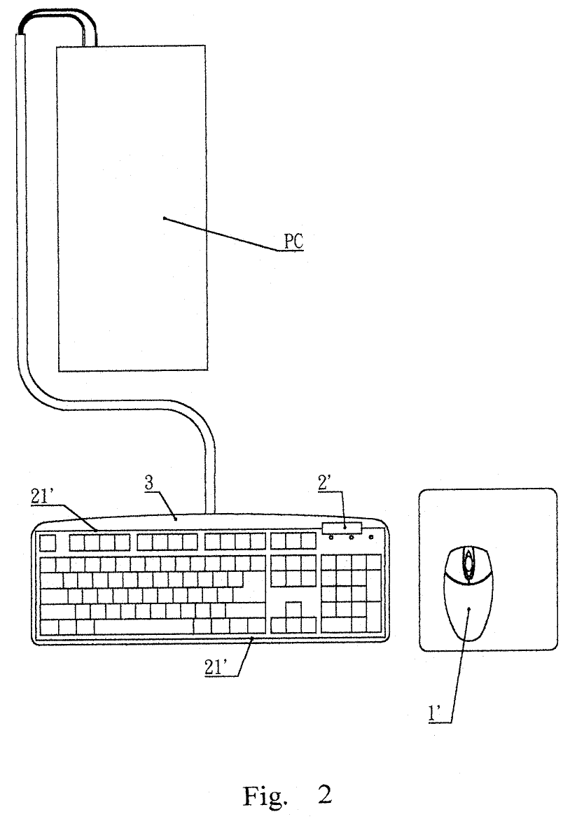

FIG. 2 is a schematic view showing the arrangement of the present invention.

### DETAILED DESCRIPTION OF THE PREFERRED EMBODIMENTS

Referring to FIG. 2, a wireless receiver 2′ is installed at a predetermined position of a keyboard 3. The wireless receiver 2′ is connected with a receiving antenna 21′ which is hidden in the edge of the keyboard 3. When the wireless mouse 1′ is at the periphery of the keyboard. Then the wireless receiver may receive signals from wireless transmitter installed in the wireless mouse 1′. After the receiving antenna 21′ receivers the signals, the wireless receiver 2′ can transfer the signals to a computer mainframe PC. Thereby, the wireless transmitter of the wireless mouse 1′ emits signals with a small power. Thereby, power is saved, cost is reduced and the space can be saved.

Thereby, in the present invention, the wireless receiver is hidden in the keyboard, and at the same time, the wireless antenna is hidden in the edge side of a keyboard. The wireless mouse may locate near the antenna so as to reduce output power. Moreover, the space for locating the antenna is reduced.

The present invention is thus described, it will be obvious that the same way be varied in many ways. Such variations are not to be regards as a departure from the spirit and scope of the present invention, and all such modifications as would be obvious to one skilled in the art are intended to be included within the scope of the following claims.

What is claimed is:

1. A wireless mouse signal transferring device having a wireless mouse, a wireless receiver, an antenna, and a keyboard; the keyboard being connected to a computer mainframe; characterized in that: the wireless receiver is hidden in a predetermined position of a keyboard and is connected with an antenna; the antenna is hidden in an edge of the keyboard; thereby, the antenna is near the wireless mouse, the space for locating the wireless mouse is saved and thus less power is required in signal transmission.
